(19) United States
(12) Patent Application Publication
(10) Pub. No.: US 2020/0174771 A1
(43) Pub. Date: Jun. 4, 2020

(54) METHOD AND SYSTEM FOR OVER THE AIR UPDATES IN A VEHICLE

(71) Applicant: GM Global Technology Operations LLC, Detroit, MI (US)

(72) Inventors: Esteban Camacho, Belleville, MI (US); Alexander X. Cermak, Grosse Pointe Woods, MI (US); Ryan Olejniczak, Macomb, MI (US)

(21) Appl. No.: 16/207,718

(22) Filed: Dec. 3, 2018

(51) Int. Cl. G06F 8/65; G06F 16/9535; G06Q 30/00; H04L 29/08

(52) U.S. Cl. CPC G06F 8/65; G06F 16/9535; H04L 67/12; H04L 67/34; G06Q 30/016

(57) ABSTRACT

A method for over the air updates in a vehicle include transmitting on and off data about the vehicle to a back office, determining at the back office an optimum time for a reminder message based on the on and off data, and querying a customer at the optimum time if a module associated with the vehicle should be updated.

### INTRODUCTION

The present disclosure relates to over the air updates in a vehicle. More specifically, the present disclosure relates to updating software of various modules in a vehicle with information from a back office at an optimum time.

In current vehicles, many of the systems residing in the vehicle, such as, navigation systems, vehicle control systems, and entertainment systems operate on software implemented in the respective system. Periodically, it may be desirable to update the software. In some vehicles, the updated software is transmitted over the air from a back office to the vehicle. In some circumstances, however, the vehicle may not operate during the software process update.

Thus, while current software update processes achieve their intended purpose, there is a need for a new and improved system and method for updating software in a vehicle, for example, an optimum time to update the software.

### SUMMARY

According to several aspects, a method for over the air updates in a vehicle include transmitting on and off data about the vehicle to a back office, determining at the back office an optimum time for a reminder message based on the on and off data, and querying a customer at the optimum time if a module associated with the vehicle should be updated.

In an additional aspect of the present disclosure, the method further includes sending a positive response to the back office from the vehicle.

In another aspect of the present disclosure, the method further includes sending from the back office to the vehicle software updates for the module.

In another aspect of the present disclosure, the method further includes communicating with the customer through a user interface.

In another aspect of the present disclosure, the back office communicates with the vehicle through a transmitter and receiver located in the vehicle.

In another aspect of the present disclosure, the vehicle includes an electronic control unit (ECU) that communicates with the transmitter and receiver, the ECU processing the information from the back office and sending the query to a user interface which displays the query to the customer.

In another aspect of the present disclosure, the ECU processes the information with a software algorithm stored in a non-transitory computer readable mechanism associated with the ECU.

In another aspect of the present disclosure, the module is at least one of a navigation system, an entertainment system, and a vehicle control system.

In another aspect of the present disclosure, the method further includes sending a negative response to the back office.

In another aspect of the present disclosure, the method further includes continually monitoring the on and off data at the back office to determine a subsequent optimum time for a subsequent reminder message.

According to several aspects, a method for over the air updates in a vehicle includes transmitting on and off data about the vehicle to a back office, determining at the back office an optimum time for a reminder message based on the on and off data, querying a customer through a user interface at the optimum time if a module associated with the vehicle should be updated, sending a positive response to the back office from the vehicle, and sending from the back office to the vehicle software updates for the module.

In another aspect of the present disclosure, the back office communicates with the vehicle through a transmitter and receiver located in the vehicle.

In another aspect of the present disclosure, the vehicle includes an electronic control unit (ECU) that communicates with the transmitter and receiver, the ECU processing the information from the back office and sending the query to a user interface which displays the query to the customer.

In another aspect of the present disclosure, the ECU processes the information with a software algorithm stored in a non-transitory computer readable mechanism associated with the ECU.

In another aspect of the present disclosure, the method further includes sending a negative response to the back office.

In another aspect of the present disclosure, the method further includes continually monitoring the on and off data at the back office to determine a subsequent optimum time for a subsequent reminder message.

According to several aspects, a system for over the air updates in a vehicle includes a transmitter and receiver that transmits on and off data about the vehicle to a back office and receives a reminder message at an optimum time to update module associated with the vehicle, and a user interface that displays the reminder message to a customer.

In another aspect of the present disclosure, the customer sends a positive response through the user interface to the back office, the back office sending to the vehicle software updates for the module.

In another aspect of the present disclosure, the customer sends a negative response through the user interface to the back office, the back office continually monitoring the on and off data to determine a subsequent optimum time for a subsequent reminder message.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a system for over the air updates in a vehicle according to an exemplary embodiment; and

FIG. 2 is a flow diagram with a set of steps for over the air updates in a vehicle according to an exemplary embodiment.

### DETAILED DESCRIPTION

The following description is merely exemplary in nature and is not intended to limit the present disclosure, application, or uses.

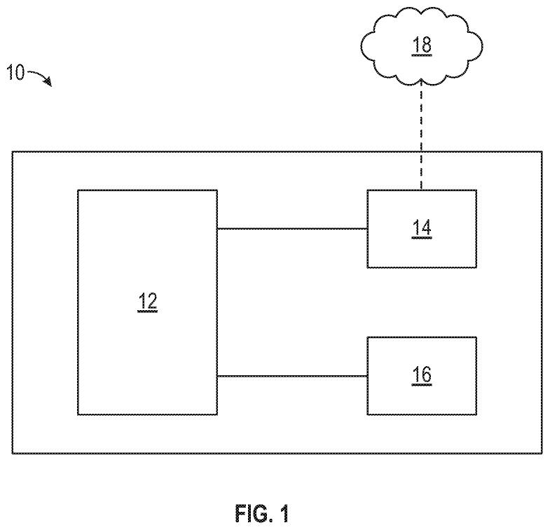

Referring to FIG. 1, there is shown a vehicle 10 that incorporates a system to update various modules in the vehicle 10 with over the air software updates from the cloud such as a back office 28. The vehicle 10 includes an electronic control unit (ECU) 12, a transmitter/receiver 14, and a user interface 16.

The transmitter/receiver 14 receives information from the back office 18 and, in turn, transmits information back to the back office 18. The transmitter/receiver 14 communicates with the ECU 12, which displays the information to a customer, such as, for example, a driver of the vehicle 10 through the user interface 16. The customer also utilizes the user interface 16 to relay information back to the back office 16.

In particular arrangements, the user interface 16 is a touchpad and the ECU 12 is implemented with an algorithm that processes information received through the transmitter/receiver and inputs from the user interface 16. In other arrangements, the user interface 16 with the vehicle 10 may be by way of various switches, levers, buttons, sensors, voice commands, facial recognition systems, and combinations thereof without departing from the scope of the present disclosure. In various arrangements, the algorithm is a software algorithm stored in a non-transitory computer readable mechanism associated with the ECU 12. The ECU 12 processes data, which includes signal inputs related to the user interface 16 as well as analog and/or digital input/output signals associates with switches, sensors and actuators in the vehicle.

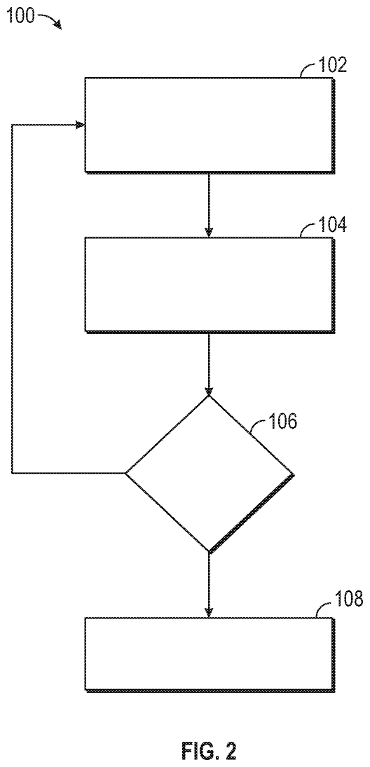

Referring to FIG. 2 and again to FIG. 1, there is shown a process 100 that updates software for various modules over the air in the vehicle 10. Specifically, the process 100 utilizes information from the back office 18 to update software for various modules, such as, for example, a navigation system, an entertainment system, a vehicle control system and any other vehicle system that operates on software that is periodically updated.

In step 102, the transmitter and receiver 14 sends information to the back office 18 regarding on/off data of the vehicle 10. The on/off data provides when the vehicle is on, for example, when the vehicle's power plant is on while the customer resides within the vehicle 10, or when the vehicle's power plant is off. In particular arrangements, this information is gathered by the ECU 12, which, in turn, relays the information to the back office 18 through the transmitter and receiver 14.

In step 104, the back office analyzes the on/off data to determine an optimum time as to when to provide a software update for a particular module. The optimum time, for example, is a likely day and time when the customer resides in the vehicle 10 to accept or reject an update of the software and when, for example, the vehicle is available for the update.

In step 106, the back office 16 asks the customer if the back office can send an update for a particular module. In particular arrangements, the query is received by the transmitter and receiver 14 which relays the information to the ECU 12. The ECU 12, in turn, provides the query to the customer through the user interface 16. The customer through the user interface 16 can provide a positive response, that is, accepts the recommended optimum time, or a negative response, that is declines the recommended optimum time. If the response from the customer is positive, the back office sends the updated software for the module to the vehicle through the transmitter and receiver 14. The information is then processed through the ECU 14 to update the module in step 108.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A method for over the air updates in a vehicle, the method comprising:
transmitting on and off data about the vehicle to a back office;
determining at the back office a time when a customer resides in the vehicle for a reminder message based on the on and off data; and
querying the customer at the time when the customer resides in the vehicle if a module associated with the vehicle should be updated, so that any update requires approval from the customer.

2. The method of claim 1 further comprising sending a positive response to the back office from the vehicle.

3. The method of claim 2 further comprising sending from the back office to the vehicle software updates for the module.

4. The method of claim 1 further comprising communicating with the customer through a user interface.

5. The method of claim 1 wherein the back office communicates with the vehicle through a transmitter and receiver located in the vehicle.

6. The method of claim 5 wherein the vehicle includes an electronic control unit (ECU) that communicates with the transmitter and receiver, the ECU processing the information from the back office and sending the query to a user interface which displays the query to the customer.

7. The method of claim 6 wherein the ECU processes the information with a software algorithm stored in a non-transitory computer readable mechanism associated with the ECU.

8. The method of claim 1 wherein the module is at least one of a navigation system, an entertainment system, and a vehicle control system.

9. The method of claim 1 further comprising sending a negative response to the back office.

10. The method of claim 9 further comprising continually monitoring the on and off data at the back office to determine a subsequent optimum time for a subsequent reminder message.

11. A method for over the air updates in a vehicle, the method comprising:
transmitting on and off data about the vehicle to a back office;
determining at the back office a time when a customer resides in the vehicle for a reminder message based on the on and off data;
querying the customer through a user interface at the time when the customer resides in the vehicle if a module associated with the vehicle should be updated, so that any update requires approval from the customer;
sending a positive response to the back office from the customer through the user interface to update the vehicle software; and
sending from the back office to the vehicle software updates for the module.

12. The method of claim 11 wherein the back office communicates with the vehicle through a transmitter and receiver located in the vehicle.

13. The method of claim 11 wherein the vehicle includes an electronic control unit (ECU) that communicates with the transmitter and receiver, the ECU processing the query from the back office and sending the query to the user interface which displays the query to the customer.

14. The method of claim 13 wherein the ECU processes the information with a software algorithm stored in a non-transitory computer readable mechanism associated with the ECU.

15. The method of claim 11 further comprising sending a negative response to the back office.

16. The method of claim 15 further comprising continually monitoring the on and off data at the back office to determine a subsequent optimum time for a subsequent reminder message.

17. A system for over the air updates in a vehicle, the system comprising:
a transmitter and receiver that transmits on and off data about the vehicle to a back office to determine when a customer resides in the vehicle for a reminder message based on the on and off data; and
a user interface that displays the reminder message to the customer to query the customer at the time when the customer resides in the vehicle if a module associated with the vehicle should be updated, so that any update requires approval from the customer.

18. The system of claim 17 wherein the customer sends a positive response through the user interface to the back office, the back office sending to the vehicle software updates for the module.

19. The system of claim 17 wherein the customer sends a negative response through the user interface to the back office, the back office continually monitoring the on and off data to determine a subsequent optimum time for a subsequent reminder message.
